(19) United States
(12) Patent Application Publication
(10) Pub. No.: US 2018/0252348 A1
(43) Pub. Date: Sep. 6, 2018

(54) FLAT-FACE QUICK ACTION COUPLER

(71) Applicant: Neil S. Robins, East Sussex (GB)

(72) Inventor: Neil S. Robins, East Sussex (GB)

(73) Assignee: HOLMBURY, LTD., Kent (GB)

(21) Appl. No.: 15/912,148

(22) Filed: Mar. 5, 2018

Related U.S. Application Data
(60) Provisional application No. 62/466,790, filed on Mar. 3, 2017.

(51) Int. Cl. F16L 37/38; F15B 20/00; F16L 29/00; F16L 29/04; F16L 29/02; F16L 37/32

(52) U.S. Cl. CPC F16L 37/38; F15B 20/005; F16L 37/32; F16L 29/04; F16L 29/02; F16L 29/002

(57) ABSTRACT

A flat-face coupler assembly for releasably coupling a fluid conduit and operative to release residual fluid pressure when disconnected from the conduit. The coupler includes a housing having a central stem centrally located having at least one end fixed in order to inhibit relative movement between the central stem and the coupler housing. The central stem defines a flat-face on a distal end that is engageable with a nose member of a male fitting. A tubular stem seat is supported for reciprocal sliding movement that at least surrounds a portion of the central stem and movable between at least two positions. In one position, the tubular stem engages the central stem in order to block communication between a port that communicates with the male fitting, and a main fluid chamber defined at least partially between the tubular stem seat and central stem. In this one position, the main chamber is also communicated with drain. When the male fitting is inserted into the coupler port, it moves the stem seat to a second position at which the port is communicated with the main chamber and fluid communication between the main chamber and drain is blocked. When the male fitting is disconnected from the coupler, the stem seat moves to its one position, closing off communication of the port with the main chamber while communicating the main chamber with the drain in order to discharge residual pressure. The flat-face coupler can be mounted in a manifold assembly and form part of a hydraulic system for operating a hydraulic attachment.

### RELATED APPLICATION

This application claims the benefit of U.S. Provisional Patent Application Ser. No. 62/466,790, filed on Mar. 3, 2017, the disclosure of which is entirely incorporated herein by reference.

### FIELD OF THE INVENTION

The present invention relates generally to fluid coupling devices and, in particular, to a flat-face decompression coupler for enhancing the functionality of quick coupling hydraulic systems.

### BACKGROUND OF THE INVENTION

A trend in the construction industry has been to utilize smaller, more versatile machinery on the job-site. For example, mini-excavators and skid-steer loaders are often used to perform a variety of tasks. In many cases, a skid-steer loader or mini-excavator is equipped with an attachment for performing a particular task. Such attachments are typically powered by an auxiliary hydraulic circuit on the skid-steer loader or mini-excavator.

Numerous attachments exist for performing a variety of tasks. For example, attachments exist for allowing a skid-steer loader to be used as a backhoe, an earth auger, an angle broom, a drop hammer, a snowplow, a brush saw, etc. These attachments typically are designed to be quickly connected and disconnected from the skid-steer loader or other machine by an operator on the job-site. The ability to quickly change attachments on the job-site makes these smaller machines more versatile than larger machines.

Quick-disconnect couplers are often used to allow quick and convenient connection and disconnection of hydraulic lines of an attachment to the auxiliary hydraulic circuit of the machinery. These types of couplers also are often used on construction equipment or agricultural tractors for connecting auxiliary circuits that power work tools or pull behind implements. The couplers can be mounted at the end of piping, hoses or in manifolds in positions that are easily accessible to the operator when connecting an attachment. Generally the couplings are in close proximity to each other.

In general, an operator manually connects the hydraulic lines of an attachment to the auxiliary hydraulic circuit of the machine. To form the connection, a plug-like coupler part and a socket like coupler part are customarily used to couple the supply/return lines. In many instances, the connection is made while internal hydraulic pressure exists in one or both of the lines to be connected. Such internal hydraulic pressure can be residual hydraulic pressure build up in the hydraulic circuit or may be due to pressure in an attachment due to thermal expansion. Regardless, hydraulic pressure in the circuit can make forming the connection more difficult, especially with standard quick-disconnect couplers.

U.S. Patent Application Publication No. US2016/0348799 discloses and claims a decompression coupling block, which includes a mechanism for releasing residual hydraulic pressure by manually operating a release member which forms part of the decompression block. This application is hereby incorporated by reference.

U.S. Pat. No. 6,588,806 is attached as Appendix 1 and discloses a flat-face quick coupling which includes a feature which is operable to resist fluid leakage to the environment during coupling. U.S. Pat. No. 6,588,806 is hereby incorporated by reference.

### DISCLOSURE OF THE INVENTION

The invention relates to a flat-face quick action coupling which is manufactured to the ISO 16028 standards. This standard covers the performance and dimensions across sizes 6.3 to 25.

The flat-face couplings are used in a variety of applications. Specifically, on auxiliary circuits of construction or agricultural machinery for connecting and disconnecting attachments.

Prior designs of the female flat-face quick action couplings have been unable to fully release trapped in pressure due to there no leakage design. Therefore, making connection with a mating half difficult.

The aim of the invention is to prevent a build-up of internal pressure within the female flat-face quick action couplings in the disconnected position, and therefore allow connection to the mating half.

The present invention provides a new and improved flat-face decompression coupler which can be operated to release residual pressure in the hydraulic system to enable hydraulic attachment hose assemblies to be coupled and decoupled from the hydraulic system. The illustrated decompression is a female flat-face decompression coupler.

According to one embodiment, the present invention comprises a flat-face coupler assembly for releasably coupling a pressurized fluid conduit or hose to a fluid pressure operated attachment. According to the invention, the coupler assembly includes a coupler housing and a central stem that is centrally held within the housing. At least one end of the central stem is rigidly held in order to inhibit relative movement between the central stem and a body member of the coupler assembly that is mounted within the housing. The central stem defines a flat-face on a distal end of the central stem. The flat-face is abutably engageable with a nose member that forms part of a male fitting that can be releasably connected to one end of the coupler assembly. The one end of the coupler assembly defines a fluid port for receiving or discharging pressurized fluid when connected to the male fitting depending on the direction of flow of the pressurized fluid.

A stem seat is supported for movement within the coupler housing between two (2) positions. In the preferred and illustrated embodiment, the stem seat is sleeve-like or tubular and is mounted for reciprocal sliding movement by a body member. In the illustrated embodiment, the body member mounted within the coupler assembly, sealingly engages a sealing surface defined by the tubular stem seat. Relative sliding movement between the tubular stem seat and the body member is permitted.

According to a preferred and illustrated embodiment, the stem seat surrounds at least a portion of the central stem and the tubular stem seat is movable between at least two positions relative to the body member and the central stem.

A main fluid chamber is at least partially defined between the central stem and the tubular stem seat. The main fluid chamber communicates with a second port spaced from the first port. The second port is adapted to receive pressurized fluid for delivery to the main chamber or for discharging pressurized fluid from the main chamber to, for example, a conduit connected to the second port that may be in fluid communication with a fluid pressure operated attachment.

According to the invention, one end of the tubular stem seat is operative to control fluid communication between the first port and the main chamber. The one end of the tubular stem seat is engageable with the distal end of the central stem in order to block communication between the first port and the main chamber while concurrently communicating the main chamber with a drain passage. In the preferred embodiment, the distal end of the central stem has an enlarged diameter portion that carries the seal that is engaged by the stem seat when it is in its first position. In the illustrated embodiment, the tubular stem seat is configured such that when it is in its first position at which it blocks fluid communication between the first port and the main chamber, it concurrently communicates the main chamber with a drain passage, thus allowing pressurized fluid in the main chamber to be discharged to a drain.

According to the illustrated embodiment, the stem seat includes an abutment that is engageable by a portion of the male fitting when the fitting is connected to the coupler assembly. According to the invention, the engagement of the abutment by the male fitting causes the stem seat to move to its second position as the male fitting is connected to the coupler. In the second position, the stem seat allows fluid communication between the first port and the main chamber while blocking fluid communication between the main chamber and the drain. When the stem seat is in its second position, pressurized fluid is allowed to flow between the first and second ports substantially unimpeded.

According to a feature of this embodiment, the one end of the stem seat includes a chamfer that is sealingly engageable with a seal carried by the distal end of the central stem. According to another feature of this embodiment, an end of the stem seat that is opposite the one end, includes a chamfer which establishes fluid communication between the main chamber and a drain passage formed in the body member, when the stem seat is in its first position. In a more preferred embodiment, the stem seat is tubular and the one end of the stem seat includes an inner chamfer that is sealingly engageable with an enlarged portion of the distal end of the central stem.

According to another feature of the preferred and illustrated embodiment, the body member carries a pair of spaced apart seals which sealingly engage the stem seat (which is tubular in the preferred embodiment) while allowing a relative sliding movement. The body member also includes a drain passage located between the spaced apart seals that is arranged such that when the tubular seat is in its second position, the spaced apart seals isolate the drain passage from the main chamber.

According to another embodiment of the invention, the coupler assembly is mounted within a manifold and includes an adaptor for mounting the coupler in a stepped bore defined by the manifold.

Additional features of the invention will become apparent and a fuller understanding obtained by reading the following detailed description made in connection with the accompanying drawings.

### BRIEF DESCRIPTION OF DRAWINGS

FIG. 1 is a schematic representation of a hydraulic system which includes a manifold assembly in which a flat-face decompression coupler, constructed in accordance with the invention, can be mounted.

FIG. 1A is an isometric view of a flat-face decompression coupler or coupling constructed in accordance with a preferred embodiment of the invention;

FIG. 2 is a side elevational view of the decompression coupler shown in FIG. 1A;

FIGS. 3 and 4 are end views of the decompression coupler shown in FIG. 1A;

FIG. 5 is an exploded view of the decompression coupler shown in FIG. 1A;

FIG. 6 is an exploded view of a subassembly indicated by the dashed line 6 shown in FIG. 5;

FIG. 7 is a cross-sectional view of a manifold assembly in which a decompression coupler, constructed in accordance with a preferred embodiment of the invention is mounted;

FIG. 8A is a sectional view of the decompression coupler shown in FIG. 1A;

FIG. 8B is a fragmentary sectional view of the decompression coupler shown in FIG. 1A;

FIG. 9 is a sectional view of the decompression coupler shown in FIG. 1A showing the pressure coupler connected to a male fitting.

### DESCRIPTION OF THE PREFERRED EMBODIMENT

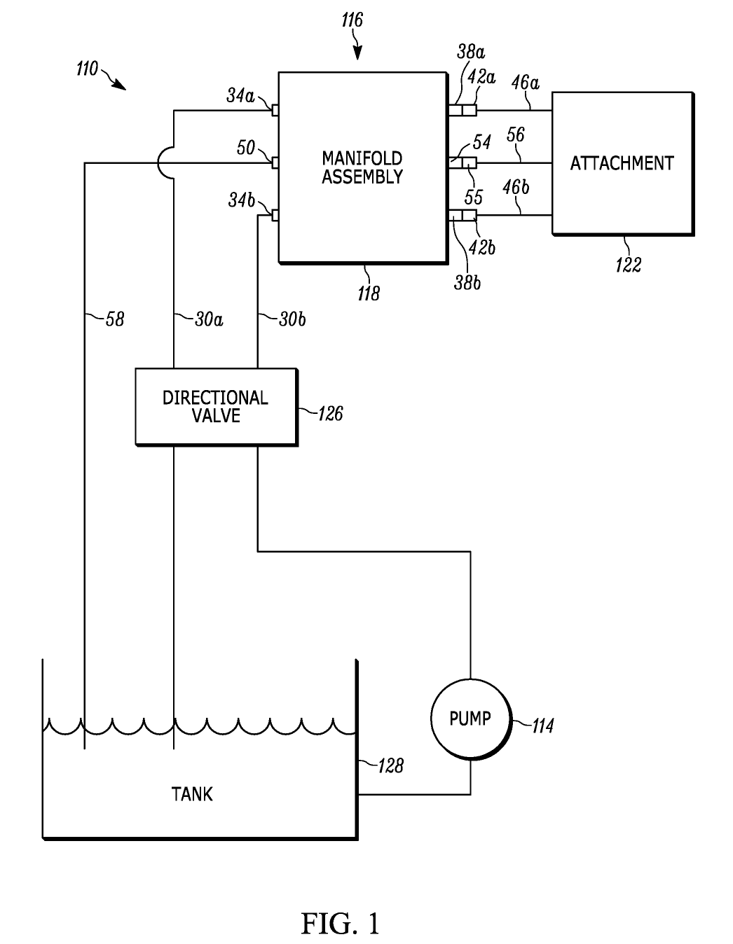

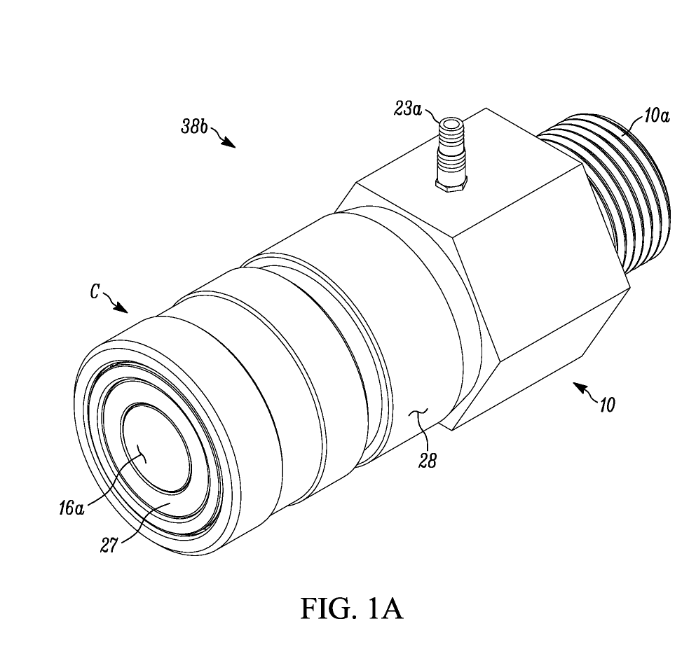

Referring now to the drawings in detail, and initially to FIG. 1, an exemplary hydraulic circuit 110 generally comprises a pump 114, a coupler/manifold assembly 116, and an attachment 122. In the illustrated embodiment, which is particularly suited for use in a mini-excavator, skid-steer loader, or similar type of machinery, there is a directional control valve 126 that directs pressurized fluid from the pump 114, which draws fluid from a tank 128, to either hydraulic line 30a or 30b depending on the desired direction of operation of the attachment 122. Hydraulic lines 30a and 30b are connected to the coupler system 116 which includes a manifold block 118. More particularly, the lines 30a and 30b are connected to fittings 34a and 34b, respectively. Fittings 34a and 34b are fluidly connected to couplers 38a and 38b, respectively.

In the illustrated embodiment, 38a is a conventional male nipple or coupler and 38b is a female coupler or coupling, this being in accordance with conventional practice. Companion or mating attachment couplers or couplings 42a and 42b connect hydraulic lines 46a and 46b of the attachment 122 to the couplers or couplings 38a and 38b. A motor case drain port 50 in the manifold 118 is connected internally with a motor case drain line coupler 54. The motor case drain line coupler 54 is coupled to a mating motor case drain line coupler 55 and motor case drain line 56.

The motor case drain port 50 is connected to the tank 128 via line 58. The motor case drain port 50 also is connected internally with the fittings 34a and 34b and couplers 38a and 38b for releasing pressure from the system 110.

In operation, the pump 114 provides pressurized fluid from the tank 128 to the directional control valve 126. Depending on the desired direction of operation, the directional control valve 126 directs the pressurized fluid to either hydraulic line 30a or 30b. By directing the fluid to one or the other of the hydraulic lines 30a, 30b, the direction of operation of the attachment 122 can be reversed. Thus, either hydraulic line 30a or 30b can supply fluid to the attachment 122 while the other hydraulic line not supplying fluid acts as a return line to return the fluid to the tank 128. The motor case drain is provided for use with auxiliary equipment that require a low pressure return, such as for draining fluid from a motor case in the auxiliary equipment. However, as will become apparent from the following description, the motor case drain port 50 and line 58 serve a further function of providing a low pressure return path to the tank 128 for fluid bled from the high pressure flow lines by means of the herein described decompression valving or coupler.

As previously mentioned, a common practice is to use a variety of interchangeable attachments 122 with an auxiliary hydraulic system 110 of a skid-steer loader or similar type of machinery. Thus, the manifold 118 of the hydraulic system 110, which functions as a coupling system, provides a convenient interface for changing attachments 122 by providing a single location for connecting and disconnecting the hydraulic lines of the attachment 122 to the auxiliary hydraulic system 110. Residual pressure, however, often remains in the system 110 after an attachment 122 is operated, and this can make it difficult to disconnect and/or connect the attachment 122. In addition spillage of hydraulic oil can also occur in some prior art designs, which is undesirable. “Flat-face” type couplers operate to inhibit oil from spilling, thus creating built up pressure and the need for a decompression mechanism. Further, thermal pressure buildup in the attachment 122 and/or auxiliary hydraulic system 110 can be an impediment to connecting an attachment 122.

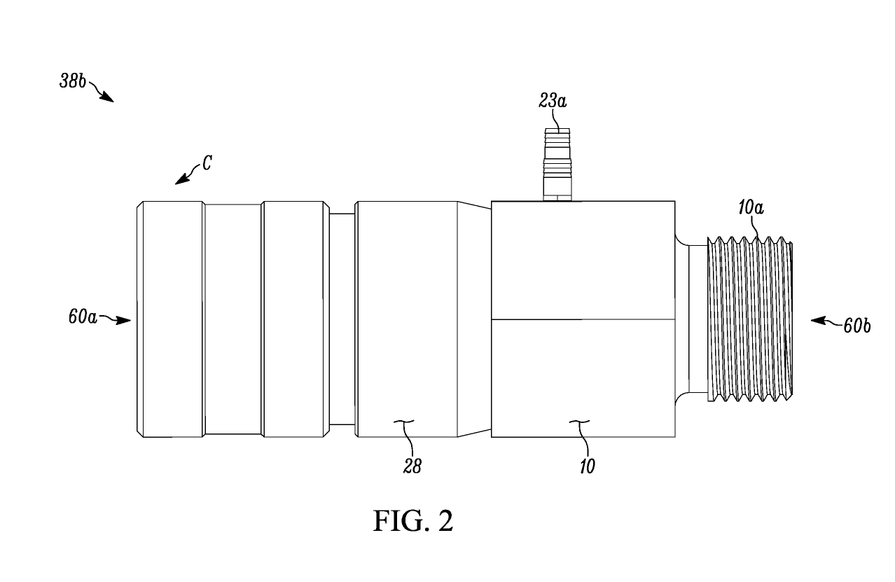

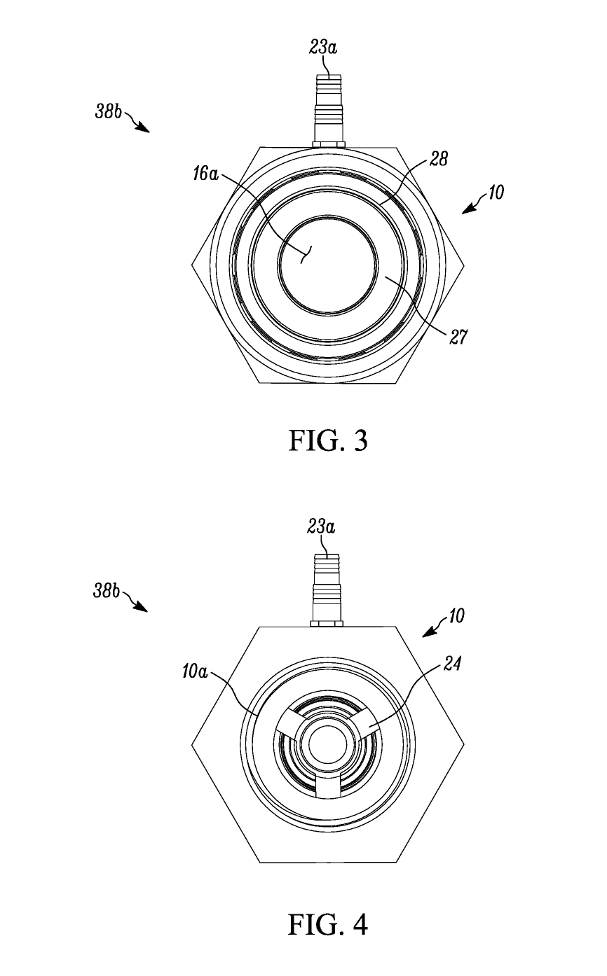

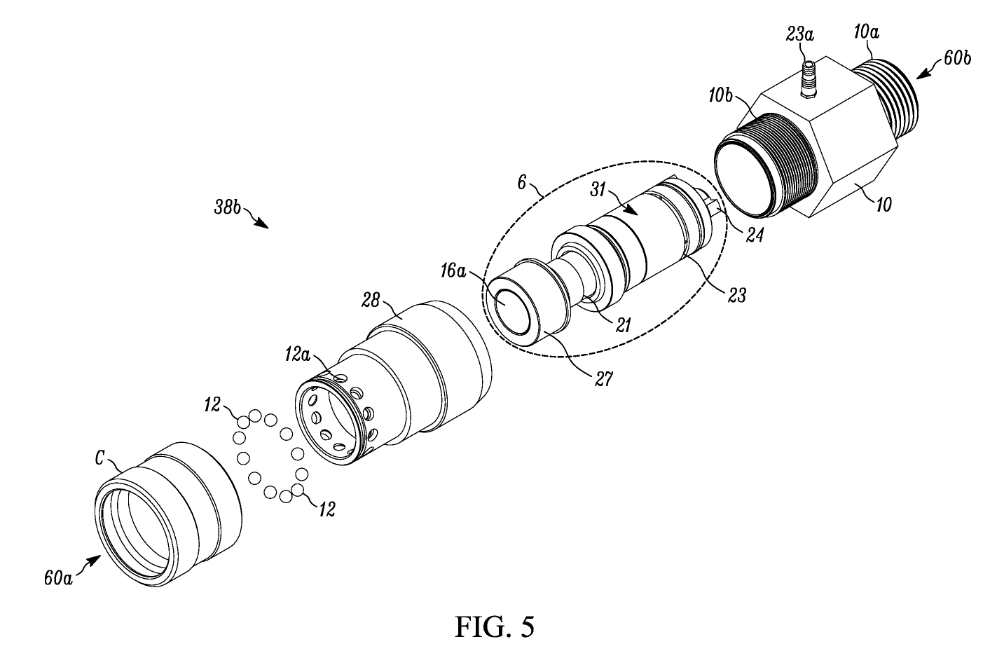

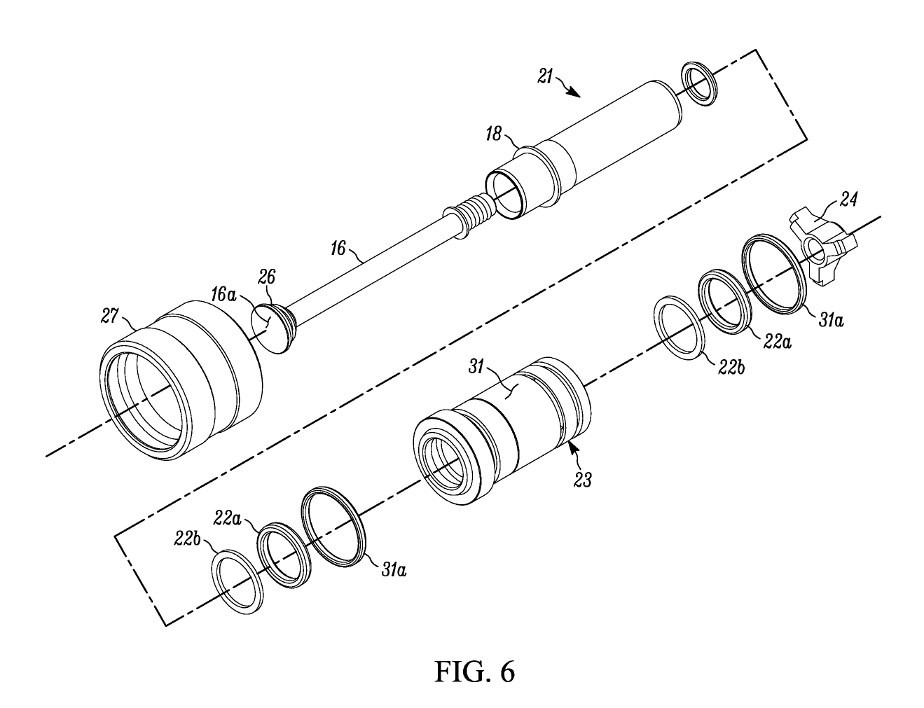

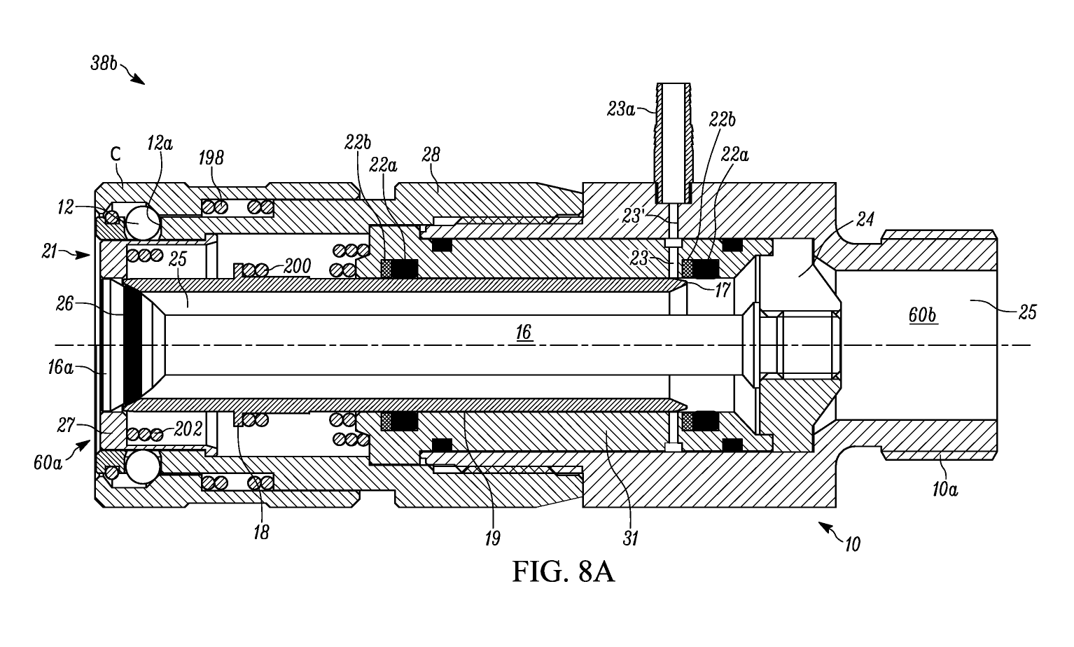

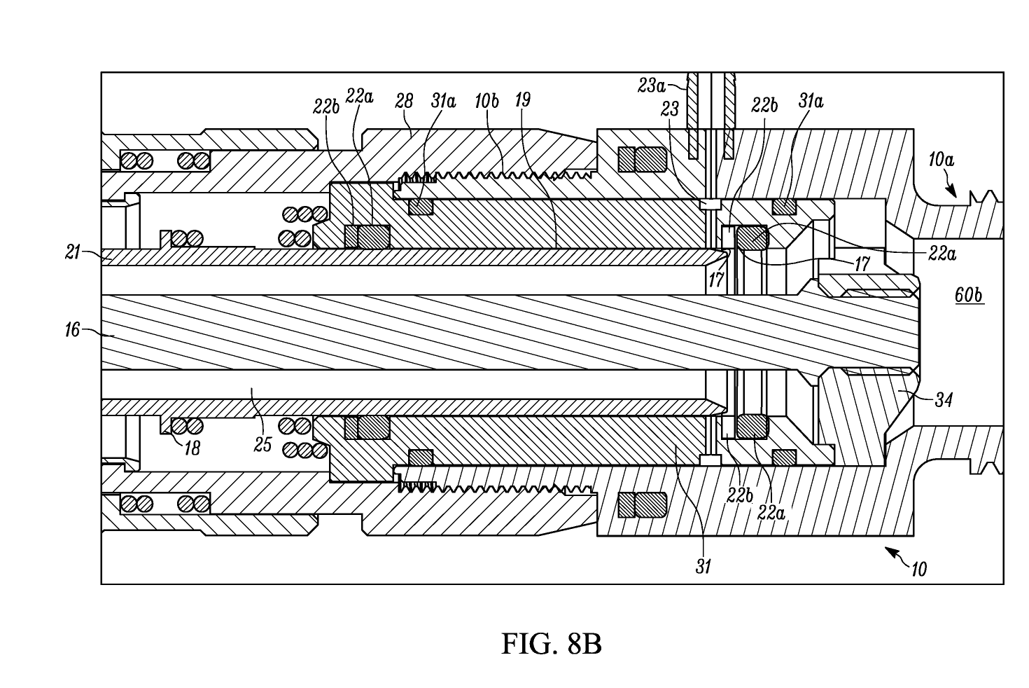

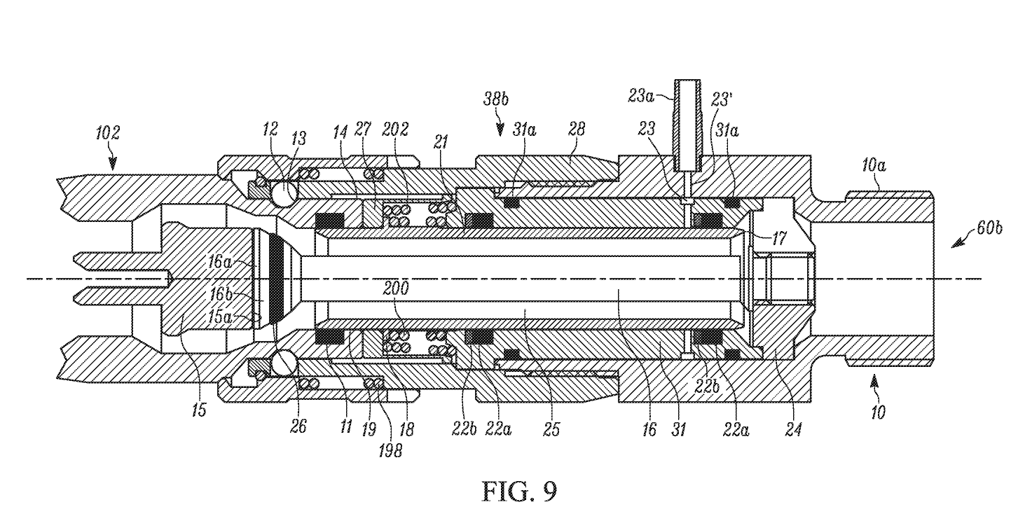

FIGS. 1A-6 illustrate the overall construction of a flat-face quick action decompression coupler or coupling 38b constructed in accordance with one preferred embodiment of the invention. The coupler 38b includes a threaded body or housing member 10 that includes a threaded connector or nipple 10a which is connectable to a hydraulic fluid source, such as a hose. Referring, in particular, to FIGS. 5 and 6, the coupler 38b includes a drain connection 23a and a central stem 16 (FIG. 6) having a central stem seal 26. In one preferred embodiment and as seen best in FIG. 8A, the stem 16 is surrounded by a sleeve-like or tubular stem seat 21. As will be explained, the stem seat 21 is shiftable left and right (as viewed in FIG. 8A) when the left end of the coupling 38b is connected and disconnected from a male nipple 102 (shown in FIG. 9) which may be part of a hose or conduit fitting. The quick coupling 38b includes a locking collar C and associated locking balls 12, which are used to releasably lock the left end of the quick coupling 38b to the male nipple or fitting 102 (shown only in FIG. 9). The locking balls 12 are loosely held in holes 12a formed in a ball housing 28. The collar C is biased towards its locking position by a coil spring 198. In the embodiment shown in FIGS. 1A-6, the ball housing or body section 28 is threadedly received by a threaded nipple 10b forming part of the body or housing section 10. As seen best in FIGS. 2 and 5, the coupler 38b defines ports 60a, 60b for receiving and discharging fluid depending on the direction of flow of the pressurized fluid.

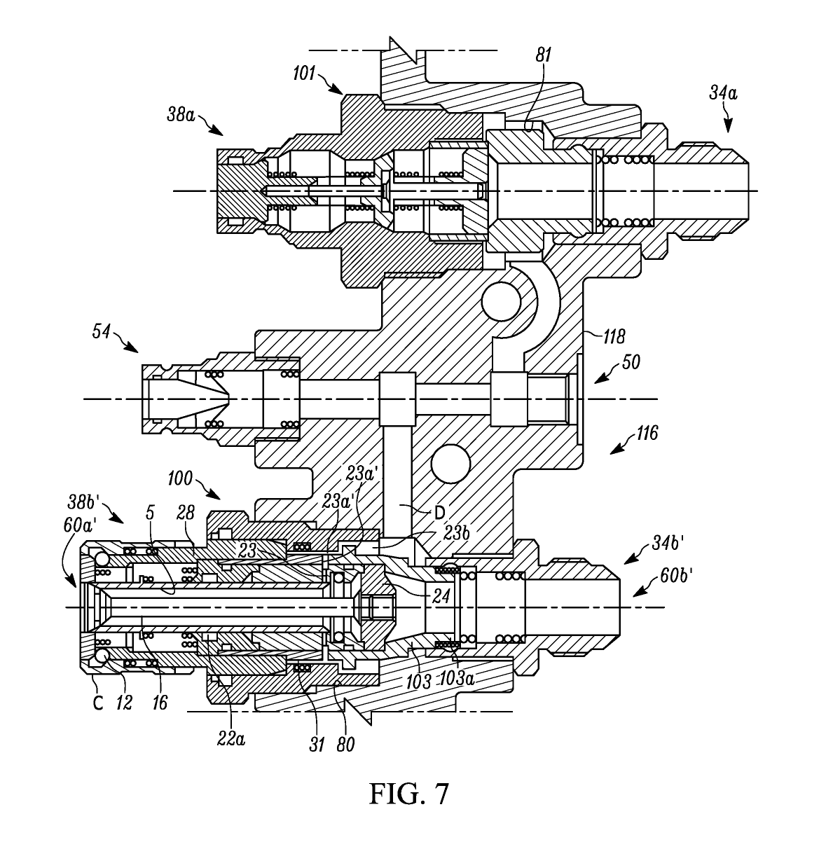

FIG. 7 illustrates a construction of the manifold assembly 116 which is shown schematically in FIG. 1. As seen in FIG. 7, the manifold assembly 116 includes the manifold 118. Another embodiment of a decompression coupler 38b′ is threadedly received in a stepped bore defined by the manifold 118. The manifold 118 also mounts a conventional, prior art quick disconnect coupler indicated generally by the reference character 38a′. The coupler 38a′ is threadedly received in an associated stepped bore 81 defined by the manifold 118 which may be the same as the stepped bore that receives the quick coupling 38b′. The connections indicated generally by the reference characters 38a, 54, 34a and 50 correspond to connections shown schematically in FIG. 1 bearing the same reference characters.

In the embodiment of the decompression coupler 38b′ shown in FIG. 7, the internal components are substantially similar to the internal components illustrated in FIGS. 1A-6. The coupler 38b′ defines fluid ports 60a′, 60b′. However, in the embodiment shown in FIG. 7, the decompression coupler 38b′ is mounted to the manifold 116 by means of a threaded, collar-like adaptor 100. In addition, the coupler 38b′ does not include a threaded connector at its rightmost end (as viewed in FIG. 7). Instead, the coupler 38b′ has an annular housing extension 103 that carries an annular seal 103a that sealingly engages an inside bore of a nipple 34b′ that is threadedly received by the manifold 116. The nipple 34b′ includes an external threaded connection by which a hydraulic hose, such as hose 30b, shown in FIG. 1, can be connected. Conventional O-rings (not shown) seal the adaptor 100 to the manifold and seal the coupler 38b′ to the adaptor 100.

It should be noted here that in FIG. 7, the assembly 116 is shown in a reverse position from that shown in FIG. 1, i.e., in FIG. 1, the attachment 122 is shown connected to the right side of the manifold 118, whereas in FIG. 7, the attachment is shown connected to the left side of the manifold 118.

It should be noted here that in FIGS. 1A-4, the quick action coupling 38b is shown with a drain fitting 23a. As seen in FIG. 7, when the quick coupling 38b′ is mounted within the manifold 118, a modified version of the quick coupling is used, which does not have a separate drain fitting 23a. Instead, a groove or passages 23a′, 23a″ or other structure are formed in the quick action coupling 38b′, which communicate the drain passage 23 with a drain D formed in the manifold 118.

Referring to FIGS. 8A, 8B, the female flat-face quick action coupling 38b is shown in the disconnected position. The threaded connector 10a of the body 10 connects the female flat-face quick action coupling 38b to a hydraulic hose such as hose/conduit 30b (see FIG. 1). In the illustrated embodiment, the connective 34b shown in FIG. 1 and the threaded nipple 10a may be the same component or separate but connected components.

FIGS. 8A and 8B show the coupler 38b disconnected from a hydraulic attachment such as attachment 122 shown in FIG. 1. FIG. 9 shows the coupler 38b connected to an attachment via hose/conduit fitting/nipple 102.

In one preferred embodiment and as seen best in FIGS. 8A and 8B, the stem seat 21 is tubular in shape and is supported for relative sliding movement by an annular female member 31 that is clamped between the ball housing 28 and the body/connector 10. As seen in FIG. 6, seals 31a seal the body member 31 to the housing member 10. The female body member 31 includes at least one drilled radial passage that forms the drain passage 23. When installed, the drilled passage 23 is aligned with another drilled passage 23′ that communicates the drilled passage 23 with the drain port 23a. The stem seat 21 is urged towards the left, as viewed in FIG. 8A by one or more coil springs 200 which act between the female body member 31 and a shoulder or annular abutment 18 forming part of the tubular or sleeve-like stem seat 21.

The central stem 16 is rigidly held in the position shown in FIG. 8A by a central stem support 24 which threadedly receives the right end of the central stem 16 (as viewed in FIG. 8A). The support 24 is also clamped in its operative position by the ball housing 28, and the annular female body member 31.

Referring to FIGS. 8A and 9, the annular female body member 31 carries spaced apart seals and backing members. In particular, seals 22a are carried on opposite sides of the annular female body member 31. The grooves that carry the seals 22a also carry associated backing seal members 22b. As seen in FIG. 9, when the tubular stem seat 21 moves to its rightmost position shown in FIG. 9, both seals 22a sealingly engaged the tubular stem seat 21 and thereby isolate the drilled drain passage 23 from the main chamber 25.

When the left end (as viewed in FIG. 8A) of the quick action coupler 38b is disconnected from the associated fitting 102, the stem seat 21 moves to its leftmost position shown in FIG. 8A. Referring in particular to FIG. 8B, when the stem seat 21 is in its leftmost position, fluid pressure in the main chamber 25 can be discharged to the drain passage 23 by a clearance (which may be formed by an outer chamfer 17 on the right end of the stem seat 21) which allows fluid communication between the main chamfer 25 and the drain passage 23. The chamfer or clearance formed at the right end of the stem seat 21 is indicated by the reference character 17. Thus, when the stem seat 21 moves to its leftmost position, as viewed in FIG. 8A, a release path for residual pressure is established between the main chamber 25 and the drain passage 23. Unlike some prior art couplers, according to this invention, the main chamber 25 is communicated to drain when the quick action coupler 38b is not connected to an attachment.

FIG. 9 shows the female flat-face quick action coupling 38b in the connected position, i.e., connected to male nipple 102. In the connected position, a male poppet 15 forming part of the male coupling 102 confronts and abutably engages an external flat-face 16a (shown best in FIGS. 1A and 6) of the central stem 16. Upon connection of the male fitting 102 to the female flat-face quick action coupling 38b, a spring biased inner sleeve 27 is pushed against the stem seat shoulder or abutment 18 by the nose 14 of the male fitting/coupler 102 thus moving the stem seat 21 from its first position to its second position. The inner sleeve 27 is biased towards its disconnected position by a coil spring 202. During this process a male nose seal 11, seals onto the stem seat sealing surface 19 and the stem seat sleeve 21 moves off of the central stem O-ring or seal 26. Once the inner sleeve 27 makes contact with the stem seat shoulder 18 the whole of the stem seat 21 is pushed back until the locking balls 12 fall into the locking ball groove 13 of the male flat-face quick action coupling 102. During this connection process the stem seat 21 engages with the seal 22a, 22b, thus terminating communication of the drain passage 23 with the main chamber 25. The male poppet 15 of the male nipple or fitting 102 is pushed back by the fixed central stem 16 thus opening the flow path between the male and female flat-face quick action couplings/fittings 102, 38b, thus allowing fluid flow between the nipple/fitting 102 and the coupler 38b.

### LIST OF REFERENCE CHARACTERS FOR COMPONENTS SHOWN IN FIGS. 8A, 8B AND 9

10. Threaded connector
11. Male Nose Seal
12. Locking Balls
13. Locking Ball Groove
14. Nose of the Male Fitting
15. Male poppet
16. Central Stem
17. Stem Seat Clearance Chamfer
18. Stem Seat Shoulder
19. Stem Seat Sealing Surface
21. Stem Seat
22a/22b. O ring and back up
23. Drain Passage
24. Central Stem Support
25. Main chamber
26. Central Stem Seal
27. Inner Sleeve
28. Ball Housing
31. Female Body Member
31a. Body Member Seals

Although the invention has been described with a certain degree of particularity, it should be understood that those skilled in the art can make various changes to it without departing from the spirit or scope of the invention, as hereinafter claimed.

1. A flat-face coupler assembly for releasably coupling a fluid conduct to a fluid pressure operated attachment, comprising:
a) a coupler housing;
b) a central stem centrally held within said housing, at least one end of said central stem being rigidly held to inhibit relative movement between said central stem and said housing;
c) said central stem defining a flat-face on a distal end of said central stem, said flat-face abutably engageable with a nose member forming part of a male fitting that can be releasably connected to one end of said coupler assembly, said one end of said coupler assembly defining a fluid port for receiving or discharging pressurized fluid;
d) a stem seat supported for movement within said coupler housing, said stem seat being movable between at least two positions;
e) a main fluid chamber at least partially defined between said central stem and said stem seat, said main fluid chamber communicating with a second port spaced from said first port, said second port adapted to receive pressurized fluid for delivery to said main chamber or for discharging pressurized fluid from said main chamber depending on a direction of flow of said pressurized fluid;
f) said stem seat operative to control fluid communication between said first port and said main chamber, said stem seat having a portion engageable with said distal end of said central stem to block communication between said first port and said main chamber, while concurrently communicating said main chamber with a drain passage when said stem seat is in its first position;
g) said stem seat including an abutment that is engageable by a portion of said male fitting such that said stem seat is moved to its second position as said male fitting is connected to said coupler;
h) said stem seat being configured to block communication between said main chamber and said drain passage when said stem seat is in its second position, whereby said main chamber is connected to said drain passage when a male fitting is not connected to said coupler and said first port is fluidly connected with said main chamber while said main chamber is not in fluid communication with said drain passage when said male fitting is attached to said coupler.

2. The flat-face coupler assembly of claim 1 wherein said stem seat is tubular and has one end sealingly engageable with the distal end of said central stem and another end of said stem seat controlling fluid communication between said main chamber and said drain passage.

3. The flat-face coupler assembly of claim 2 wherein said tubular stem seat is slidably received by a body member forming part of said coupler housing and sealingly engaging said tubular stem seat with spaced apart seals such that when said stem seat is in its second position, said spaced apart stem seals block fluid communication between said main chamber and said drain passage.

4. The flat-face coupler assembly of claim 2 wherein said tubular stem seat defines a sealing surface that is sealingly engageable by a portion of said male fitting, when said male fitting is connected to the coupler assembly.

5. The flat-face coupler assembly of claim 2 wherein said stem seat includes a chamfer at its other end, said chamfer allowing fluid communication between said main chamber and strain passage when said stem seat is in its first position.

6. The flat-face coupler assembly of claim 2 wherein said one end of said seat includes an inner chamfer that is sealingly engageable with a seal carried by an enlarged diameter portion of said distal end of said central stem.

7. The flat-face coupler assembly of claim 1 wherein said stem seat is biased towards its first position by a spring.

8. The flat-face coupler assembly of claim 1 wherein said portion of said male fitting is abutably engageable with an inner sleeve forming part of said coupler assembly, said inner sleeve engageable with said stem seat abutment and operative to urge said stem seat towards its second position when said male fitting is connected to said coupler assembly.

9. The flat-face coupler assembly of claim 8 wherein said inner sleeve is spring-biased towards a disconnected position.

10. A flat-face coupler assembly for releasably coupling pressurized fluid conduct to a fluid pressure operated attachment, comprising:
a) a coupler housing;
b) a central stem centrally held within said housing, at least one end of said central stem being rigidly held to inhibit relative movement between said central stem and a body member of said coupler assembly;
c) said central stem defining a flat-face on a distal end of said central stem, said flat-face abutably engageable with a nose member forming part of a male fitting that can be releasably connected to one end of said coupler assembly, said one end of said coupler assembly defining a fluid port for receiving or discharging pressurized fluid;
d) a tubular stem seat supported for reciprocal, sliding movement within said coupler housing, said stem seat surrounding at least a portion of said central stem, said tubular stem seat being movable between at least first and second positions;
e) a main fluid chamber at least partially defined between said central stem and said tubular stem seat, said main fluid chamber communicating with a second port spaced from said first port, said second port adapted to receive pressurized fluid for delivery to said main chamber or for discharging pressurized fluid from said main chamber;
f) one end of said tubular stem seat operative to control fluid communication between said first port and said main chamber, said one end of said tubular stem seat engageable with said distal end of said central stem to block communication between said first port and said main chamber, while concurrently communicating said main chamber with a drain passage;
g) said tubular stem seat including an abutment that is engageable by a portion of said male fitting such that said tubular stem seat is moved to its second position as said male fitting is connected to said coupler;
h) said tubular stem seat being configured to block communication between said main chamber and said drain passage when said tubular stem seat is in its second position, whereby said main chamber is connected to said drain passage when a male fitting is not connected to said coupler and said first port is fluidly connected with said main chamber while said main chamber is not in fluid communication with said drain passage when said male fitting is attached to said coupler.

11. The flat-face coupler assembly of claim 10 wherein said distal end of said central stem has an enlarged diameter and carries the seal that is engageable by said one end of said tubular stem seat and said stem seat having an opposite end defining a chamfer for allowing fluid communication between said main chamber and said drain when said stem seat is in its first position.

12. The flat-face coupler assembly of claim 11 wherein said central stem is rigidly held by a stem support, the central stem support being clamped within said coupler housing by a ball housing, a body member that slidably receives said tubular stem seat and another portion of said coupler housing.

13. A hydraulic system for operating a hydraulic attachment that is releasably connected to said hydraulic system, comprising:
a) a directional valve communicating with a source of pressurized fluid and a return conduit for returning hydraulic fluid to a tank;
b) said directional valve including a pair of conduits communicating with a manifold assembly, said directional valve controlling which one of said pair of conduits delivers pressurized fluid to said manifold assembly and which conduit returns fluid to said tank;
c) said manifold assembly including at least one flat-face coupler assembly for communicating an associated conduit with said hydraulic attachment;
d) said flat-face coupler assembly, comprising:
i) a coupler housing;
ii) a central stem centrally held within said housing, at least one end of said central stem being rigidly held to inhibit relative movement between said central stem and said housing;
iii) said central stem defining a flat-face on a distal end of said central stem, said flat-face abutably engageable with a nose member forming part of a male fitting that can be releasably connected to one end of said coupler assembly, said one end of said coupler assembly defining a fluid port for receiving or discharging pressurized fluid;
iv) a stem seat supported for movement within said coupler housing, said stem seat being movable between at least two positions;
v) a main fluid chamber at least partially defined between said central stem and said stem seat, said main fluid chamber communicating with a second port spaced from said first port, said second port adapted to receive pressurized fluid for delivery to said main chamber or for discharging pressurized fluid from said main chamber depending on a direction of flow of said pressurized fluid;
vi) said stem seat operative to control fluid communication between said first port and said main chamber, said stem seat having a portion engageable with said distal end of said central stem to block communication between said first port and said main chamber, while concurrently communicating said main chamber with a drain passage when said stem seat is in its first position;
vii) said stem seat including an abutment that is engageable by a portion of said male fitting such that said stem seat is moved to its second position as said male fitting is connected to said coupler;
viii) said stem seat being configured to block communication between said main chamber and said drain passage when said stem seat is in its second position, whereby said main chamber is connected to said drain passage when a male fitting is not connected to said coupler and said first port is fluidly connected with said main chamber while said main chamber is not in fluid communication with said drain passage when said male fitting is attached to said coupler.

14. The hydraulic system of claim 13 wherein said stem seat of said flat-face coupler assembly is tubular and has one end sealingly engageable with the distal end of said central stem and another end of said tubular stem seat controlling fluid communication between said main chamber and said drain passage.
